(19) United States
(12) Patent Application Publication
(10) Pub. No.: US 2011/0157022 A1
(43) Pub. Date: Jun. 30, 2011

(54) Bracelets for wearing by a user

(76) Inventor: Tim Goldburt, Ardsley, NY (US)

(21) Appl. No.: 12/655,418

(22) Filed: Dec. 29, 2009

(51) Int. Cl. G06F 3/02

(52) U.S. Cl. 345/169

(57) ABSTRACT

A bracelet for wearing by a user has a hollow body; an electrical or electronic device; and a user-operated control for controlling the device by a user.

### BACKGROUND OF THE INVENTION

The present invention relates to bracelets for wearing by a user, for example on his or her arm.

Bracelets for wearing by a user are sometimes provided with some elements and devices mounted on them.

Bracelets for wearing by a user of this type are known in the art. It is believed that such bracelets for wearing by a user can be further improved.

### SUMMARY OF THE INVENTION

Accordingly, it is an object of the present invention to provide a bracelet for wearing by a user which is a further improvement of the existing bracelets for wearing by a user of this type.

In keeping with these objects and with others which will become apparent hereinafter, one feature of the present invention, briefly stated, in a bracelet for wearing by a user, comprising a hollow body; an electrical or electronic device; and means for controlling the device by a user.

Another feature of the present invention resides in that the device includes an electronic display, and the means for controlling is formed as an alpha-numerical keyboard.

A further feature of the present invention resides in a battery for providing a battery-operated operation of said electronic display.

Still a further feature of the present invention resides in a microprocessor for operating said electronic display digital content.

Still a further feature of the present invention resides in input means connectable to an output device.

The electrical or electronic device can be operative for producing visual messages, audio messages, light, decorative message, running light, and combinations thereof.

The device can be accommodated in a cavity of the hollow body, and covered from outside. It can be ring-shaped.

The device can have light generating means and also sensing means selected from the group consisting of a contact sensor, a movement sensor, and both and operative for activating said light generating means for producing light in response to an action selected from the group consisting of a contact, a movement, and both in a vicinity of said device. The light generating means and the sensing means can be configured so that depending on whether there is contact or a movement in the vicinity of the container, said light generating means emits different lights.

The electrical or electronic device can be held by tightly fitting into a recess of the body or by tightly embracing a part of the body in the recess, or by both actions at the same time, etc.

Adhesive means can be provided for improving holding of said electronic device and said recess of said body.

A further feature of the present invention resides in that said electrical or electronic device and the hollow body form together a circumferentially extending unit which as a whole is fittable on a surface of a part of a user's body and tightly held on the latter.

The unit can extend over the whole circumference or over only a part of it.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view showing a bracelet for wearing by a user in accordance with a first embodiment of the present invention;

FIG. 2 is a view showing a bracelet for wearing by a user in accordance with a second embodiment of the present invention;

FIG. 3 is a view showing a bracelet for wearing by a user in accordance with a third embodiment of the present invention;

FIG. 4 is a view showing a bracelet for wearing by a user in accordance with a further embodiment of the present invention;

FIG. 5 is a view showing a bracelet for wearing by a user in accordance with a further embodiment of the present invention;

FIG. 6 is a view showing a bracelet for wearing by a user in accordance with a further embodiment of the present invention;

FIG. 7 is a side view of a bracelet for wearing by a user, provided with an electrical/electronic devices of a further embodiment;

FIG. 8 is a perspective view of the electrical/electronic device of the inventive bracelet for wearing by a user;

FIG. 9 is a longitudinal cross-section of the electrical/electronic device of the inventive beverage container;

FIG. 10 is a transverse cross-section of the electrical/electronic device of the inventive beverage container;

FIG. 11 is a view showing a cross-section of a bracelet for wearing by a user in accordance with the present invention showing a hollow body, electrical or electronic device, and a member located between the hollow body and the electrical or electronic device;

FIG. 12 is a perspective view of the electrical or electronic device;

FIGS. 13 and 14 are views showing two opposite sides of a member insertable between the electrical or electronic device and the hollow part of the bracelet for wearing by a user;

FIG. 15 is a view showing another embodiment of electrical or electronic device of the bracelet for wearing by a user in accordance with the present invention;

FIGS. 16 and 17 are views showing two opposite sides of the electrical or electronic device of the bracelet for wearing by a user in accordance with the present invention;

FIG. 18 is a view showing a cross-section of a part of a wall of the hollow body and of the electrical or electronic device;

FIG. 19 is a view showing a back side of the electrical or electronic device of the inventive bracelet for wearing by a user of FIG. 19;

FIG. 20 is a view showing a back side of the electrical or electronic device of FIG. 19;

FIG. 21 shows an intermediate element between the electrical or electronic device and a bottom of a recess in the bracelet for wearing by a user;

FIG. 22 is a view showing a transparent/translucent band which retains the electrical or electronic device on the bracelet for wearing by a user;

FIG. 23 is a perspective view of a bracelet for wearing by a user in accordance with a further embodiment of the present invention;

FIG. 24 is a view of the bracelet for wearing by a user of FIG. 23 in assembled condition;

FIG. 25 is a view showing a cross section of FIGS. 21-24;

FIG. 26 is a perspective view of the container in accordance with another embodiment of the present invention;

FIG. 27 is a view of the container of FIG. 26 in assembled condition;

FIG. 28 is a view showing a cross section of FIG. 27; and

FIG. 29 is a view of a portion of the bracelet for wearing by a user of FIG. 28;

FIGS. 30 and 31 are views showing the cross-section of the bracelet for wearing by a user with the electronic device in accordance with two further embodiments of the present invention; and

FIGS. 32 and 33 are views showing the cross-section of the bracelet for wearing by a user with the electronic device in accordance with two further embodiments of the present invention.

### DESCRIPTION OF THE PREFERRED EMBODIMENTS

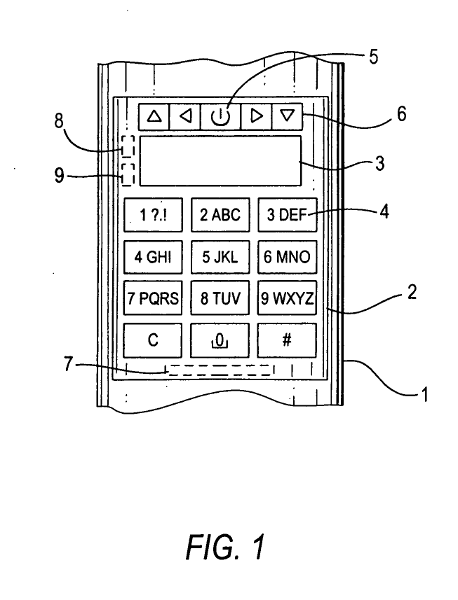

FIG. 1 shows a first embodiment of a bracelet for wearing by a user in accordance with the present invention. The bracelets for wearing by a user have a hollow body which is identified with reference numeral 1. The bracelet for wearing by a user further has an electrical or electronic device identified as a whole with reference numeral 2.

The device includes an electronic display which can be formed as a conventional computer-type screen and identified with reference numeral 3. The device further has user-operated control means formed for example as an alpha numerical keyboard 4 with a plurality of alpha numerical signals. The device also includes an on/off button 5 and control buttons 6 including up, a left, right, and down buttons.

In order operate the device 2 on the bracelet for wearing by a user, a user turns the on/off button to the position on and operates the keys of the keyboard 4. As a result, a curser (arrow) appears on the display 3. With the use of the buttons 6, the user can move the curser to the desired location on the display or the desired image on the display.

The device has also a battery 7, a microprocessor 8, and a memory 9 which can be built in the device 2, for example in an area behind the alpha numerical keyboard. The images to be displayed are stored in the memory and retrieved from it to be shown on the display.

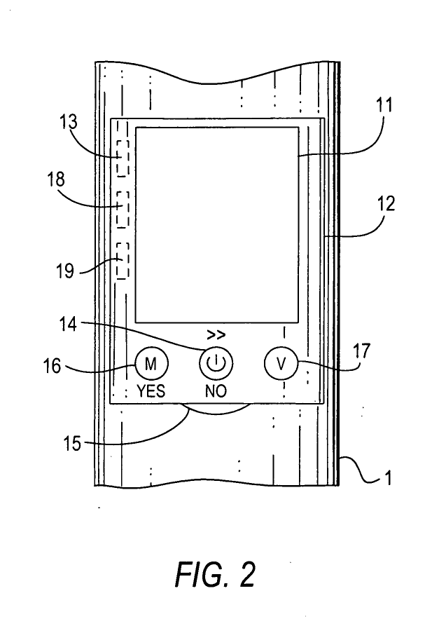

The bracelet for wearing by a user shown in FIG. 2 has the hollow container body 1 with a device for displaying and controlling images identified with reference numeral 12. The device 12 has an electronic display 11, on which digital photos and/or videos can be displayed. An on/off switch button is identified with reference numeral 14. The control button provides switching of modes between the following modes: MANUAL, PHOTO, VIDEO. The device is further provided with a connection to a computer to change a digital content to be displayed on the display and formed for example as a USB cable input 15. Finally a control button 16 is provided for the purpose which will be explained herein below.

In order to operate the device of the bracelet for wearing by a user shown in FIG. 2, a user turns on the on/off switch 14, and with the control button 16 changes the corresponding mode between the modes menu, photo, video, which can be supplied through the USB cable input 15 from a computer. With the button 17, users can vote on each photo/video, or in other words to rate them yes/no to indicate whether they like or they do not like the photo/video. The device also includes a memory 13, a microprocessor 18, and a battery 19.

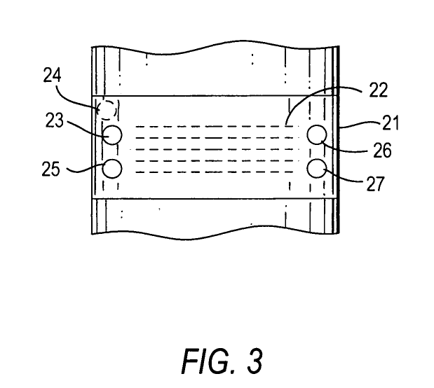

In the embodiment of FIG. 3, a bracelet for wearing by a user has the hollow container body 1 and a device 21 for displaying an alpha numerical content. The device can have a display 22 formed as an LED display screen, and on/off button 23, a battery 24, an enter button 25 to save user input when changing letters or numbers or symbols, a user's control including up 26 and down 27 buttons, and a not shown processor.

In operation of the embodiment shown in FIG. 3 the user turns the on/off button to on position, and with the control buttons 26, 27 scrolls up or down so as to change the alpha numerical content which is shown on the display 22.

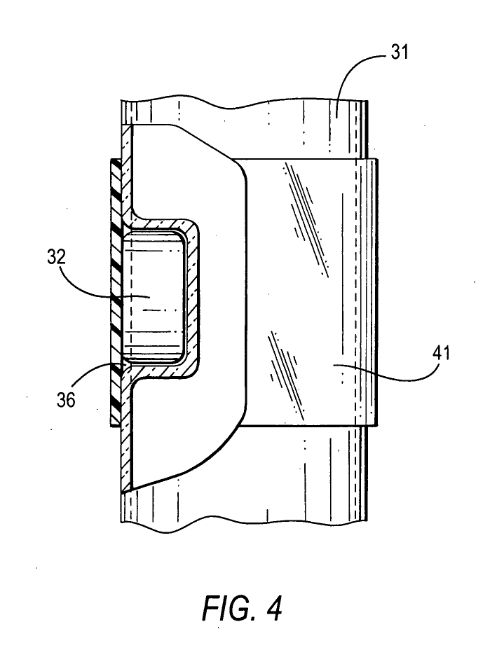

A bracelet for wearing by a user with the present invention shown in FIGS. 4-8 has a hollow body which is identified with reference numeral 31 and defines an inner space for accommodating an alcoholic beverage or a non alcoholic beverage. In accordance with the present invention a device selected from the group consisting of an electrical device and an electronic device identified with reference numeral 32 is integrated in the container of the invention.

The electrical device or electronic device in the container in accordance with the present invention can provide visual messages which can be prerecorded messages or life messages. For example, the device can be a TV display, a PDA display, a PC display, a clock, a decorative display, a running line display, an advertising display, etc. Once activated it produces corresponding visual messages.

The device in accordance with the present invention can be formed so that it produces prerecorded or live audio messages. The device for generating audio messages can be a device for broadcasting radio messages, satellite radio messages, I-pod messages, etc.

The device in accordance with the present invention can be also configured as a device which produces prerecorded or life decorative messages, for example running light, blinking lights, etc.

It is to be understood that it is within the spirit of the invention to provide such a device which combines the visual messages, the audio messages, the light messages, etc., and even other messages not specifically mentioned.

The electrical or electronic device in accordance with the present invention can be provided with wireless connections. The light messages can be produced for example by providing luminescent paints on the container with a light emitting device which excites the luminescent paint and makes it glow.

In accordance with another embodiment of the present invention the electrical or electronic device can be formed as a power source 32. The power source can be formed for example by solar cells, batteries, rechargeable batteries, or combinations thereof.

In accordance with the present invention the electrical or electronic device can be also formed as the power source 32 configured for supplying power to an exterior device for any purpose, which is not associated with the container, for example to charge a cell phone located outside of the container, to power a light source located outside of the container, etc.

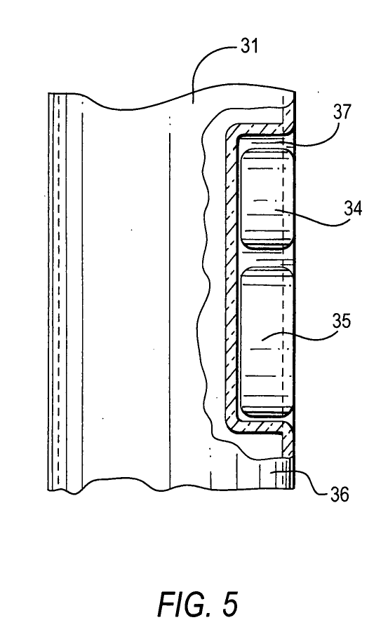

In accordance with still another embodiment of the present invention, the device can include an electrical or an electronic device 34 and also a power source 35 provided for supplying power to it for example a TV display powered by solar cells, etc, both integrated in the container as shown in FIG. 5.

In accordance with one embodiment of the present invention shown in FIG. 4, the hollow body 31 can be provided with a recess 36 which is formed in a peripheral wall 36 of the hollow body. The electrical or electronic device 32 of the present invention is accommodated in the recess.

In accordance with a further embodiment shown in FIG. 5, the container 31 is provided with an elongated channel 37 formed in the peripheral wall 36. The electrical or electronic device 32 of the present invention is accommodated in the channel.

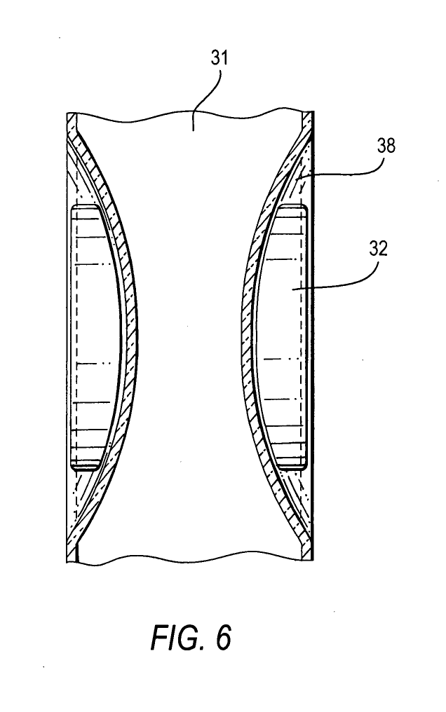

In accordance with a still further embodiment shown in FIG. 6, the hollow body 31 is provided with an annular neck-shaped narrowing groove 38 31. The electrical or electronic device 32 is accommodated in the annular groove. The electrical or electronic device 32 can be formed as a ring-shaped device which surrounds the neck-shaped portion and can have an outer diameter correspondingly to the outer diameter of the body.

Means for covering the electrical or electronic device of the present invention are further provided. They are used so as not to disturb an outside appearance of the bracelet for wearing by a user. The means for covering can be formed as a plastic cover 41. The plastic cover can be formed for example as a sleeve which is fittable over the body of the bracelet for wearing by a user in such a way as to cover the electrical or electronic device integrated in the bracelet for wearing by a user. The covering means can be also formed as a plastic enclosure which is connected with the body of the bracelet for wearing by a user, for example by adhesive and the like.

Generally, the electronic or electrical device 32 can be integrated in the bracelet for wearing by a user so that it does not extend outwardly beyond its shape.

When the bracelet for wearing by a user is designed in accordance with the present invention, then in addition to its primary decorative function, it obtains completely new functionality, namely by acting as a system including a bracelet for wearing by a user beverage and an electronic or electrical device which provides corresponding additional functions.

The electrical or electronic device integrated in the bracelet for wearing by a user in accordance with the present invention can operate in the bracelet for wearing by a user, it can be removed from the bracelet for wearing by a user and operate separately, it can operate in wireless or in wired fashion, it can cooperate with an exterior device, etc.

The cover which covers the electrical or electronic device in or on the bracelet for wearing by a user can be formed as a transparent cover or a non-transparent cover. The hollow body can be also composed of a transparent material or a non-transparent material.

FIG. 4 shows that the device 32 can be configured as a ring-shaped device composed of a plurality (at least two) segments. The cover 41 can be configured as a shell which embraces the device and is composed of shell portions, which can be connected with one another by inter-engaging projections and grooves, for example with snap action. This construction can be used with the embodiments shown in other figures.

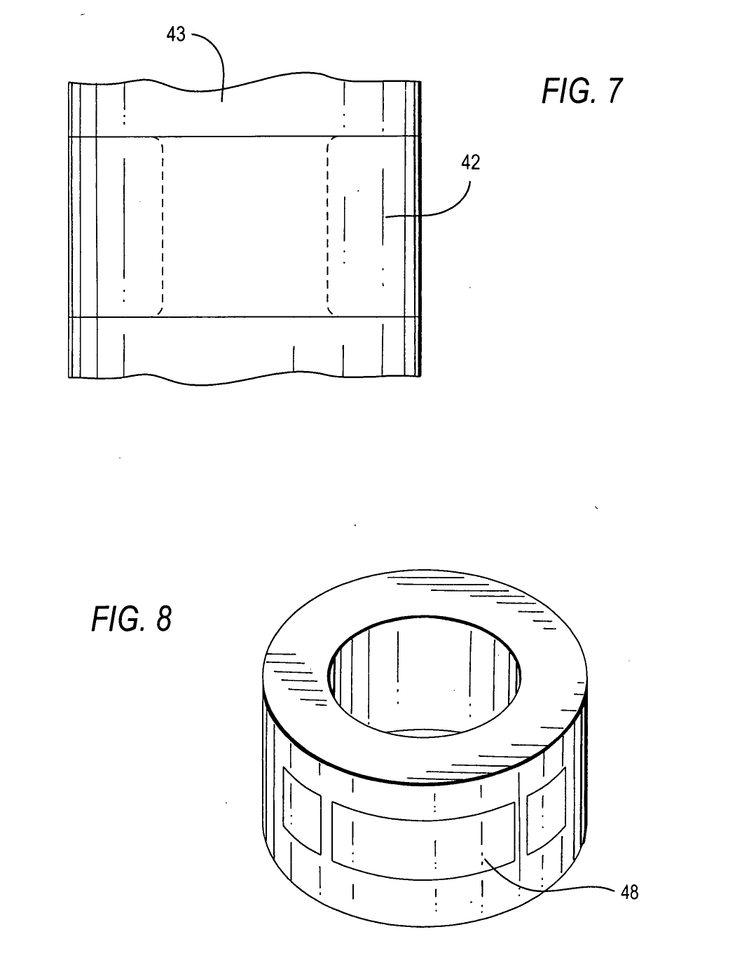

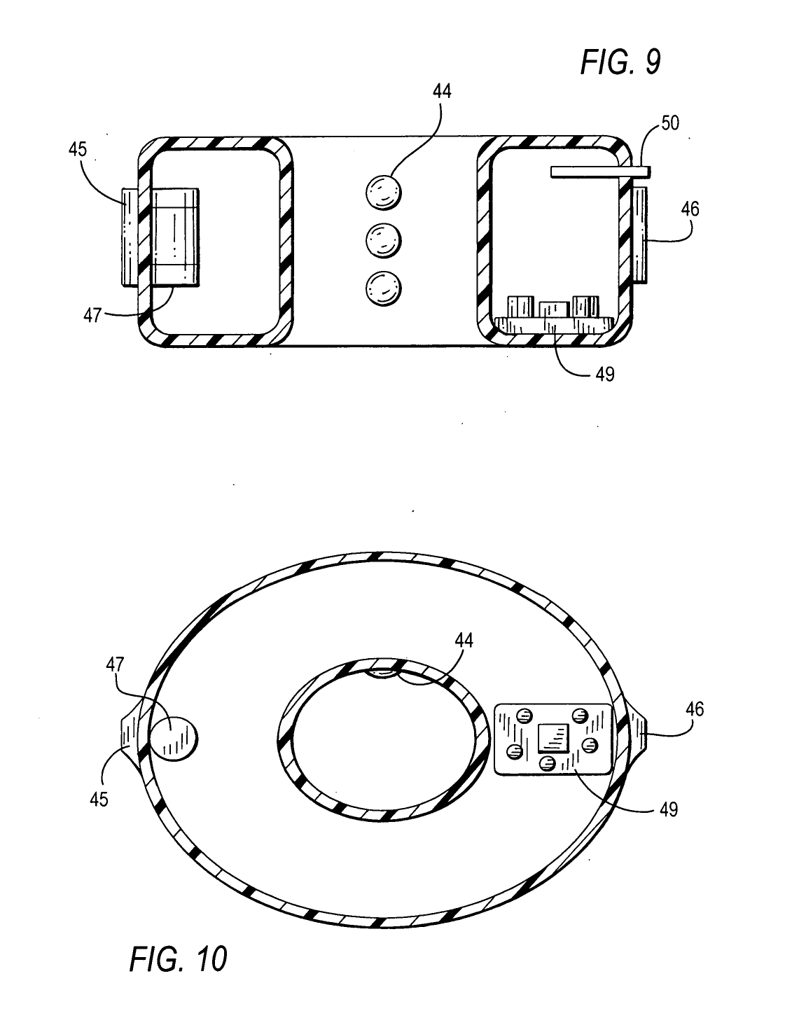

A bracelet for wearing by a user in accordance with the present invention for alcoholic or non alcoholic beverages shown in FIGS. 7-10 has a hollow body which is identified with reference numeral 43 and defines an inner space.

The beverage container further has a device which can be an electrical device and identified as a whole with reference numeral 42. The device 42 is associated with the hollow body part, or more particularly it is arranged on it, for example on a narrowed part of the hollow body part. It can be formed as an annular device having an inner hollow space, as disclosed for example in our patent application Ser. No. 11/558,494.

The device 42 has indicating means 44 formed for example by a light generating means. The light generating means can include several light emitting diodes, each of which can emit light of a corresponding different color. The light emitting diodes can be mounted for example on an inner cylindrical wall of the device and face the interior of the hollow body.

The device further has sensing means. The sensing means include a contact sensor which is identified with reference numeral 45. The contact sensor 45 operates in response to a contact, for example a touch of the sensor 45 by a user.

The sensing means further have a motion sensor which is identified with reference numeral 46. The motion sensor is configured so that it operates in response to a motion of a person or an object in the vicinity of the bracelet for wearing by a user.

As can be seen from the drawings, the contact sensor 45 can be mounted on an outer circumferential wall of the device 42 at one circumferential location, while the motion sensor 46 can be also mounted in the outer circumferential wall at another location which is circumferentially spaced from the contact sensor.

The device further has an electric power source for powering the elements of the inventive device. The power source can include for example batteries identified with reference numeral 47. The power source alternatingly, or additionally can include solar panels arranged for example on the outer circumference of the cylindrical wall of the device.

Image producing means are further provided for displaying a text information in form of a running strip for displaying video images such as movies, etc. These means can be formed for example by a liquid crystal indicator as identified with reference numeral 48 as arranged on the outer surface of the cylindrical wall of the device.

The device is provided with a control unit formed for example as a microprocessor 49. It is connected with all elements device, for example by corresponding wires.

The device further has a flash memory storage device for example a flash memory stick 50 for loading text and image data to be displayed by the image generating means 48.

The device of the inventive beverage container shown in FIGS. 7-10 operates in the following manner.

When for example the contact sensor 45 is activated by touching it by a person or the motion sensor 46 is activated in response to the presence of a person in the vicinity of it, the indicating means generates a corresponding visual indication. For example, in response to touching of the contact sensor 45 the light emitting diodes can be activated so that red and orange colors are alternatingly emitted in a continuous succession one after the other. When the motion sensor 46 is activated, red and blue colors can be emitted in a continuous succession one after the other. It is understand that for this purpose the light emitting diodes include red, orange and blue diodes which are controlled correspondingly by the microcontroller 49 in response to the sensing of the corresponding situation by the contact sensor 45 and the motion sensor 46.

When the microcontroller 49 receives signals from the sensor 45 and 46 it also activates image generating means 48 for displaying a text information, video images, etc., and this means display corresponding text information, for example in form of a running strip. The text information can include news, advertising, and any other information. This information can be either transmitted remotely from a source, or memorized in the device and activated in response to the operation of the microcontroller 49.

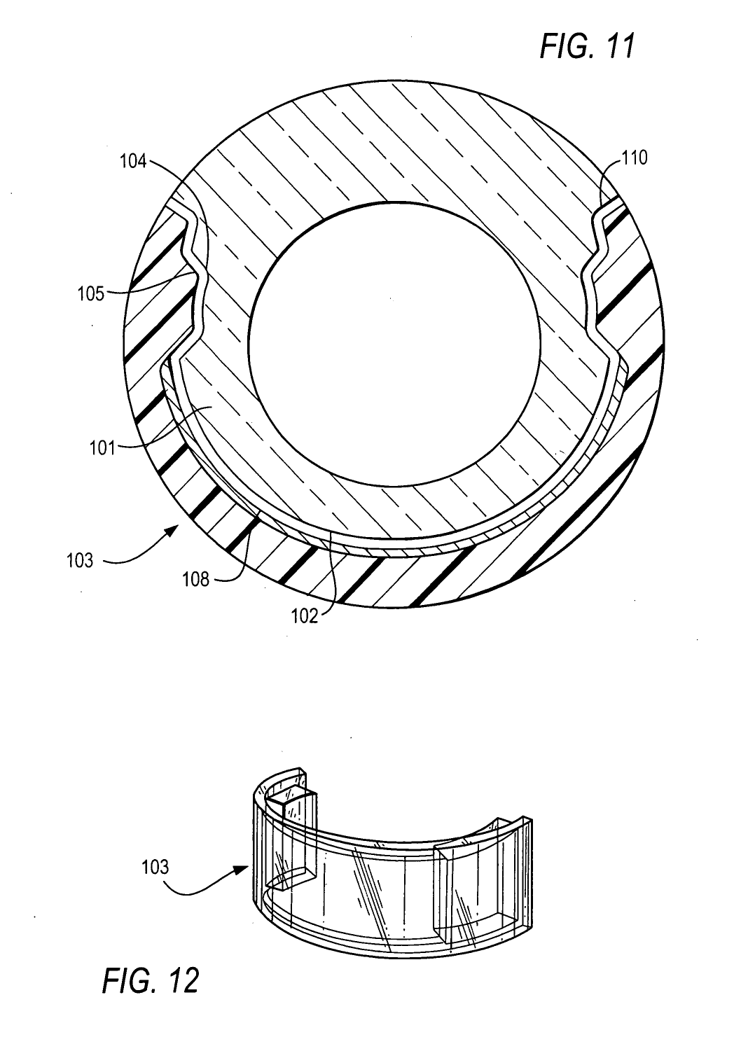

A bracelet for wearing by a user in accordance with the present invention shown in FIG. 11 has a hollow body which is identified with reference numeral 101.

The hollow body 101 has a recess provided in its wall and extending from its outer surface radially inwardly as identified with reference numeral 102.

The bracelet for wearing by a user in accordance with the present invention has an electronic or electrical device which is identified with reference numeral 103.

The electrical or electronic device 103 has a shape which is substantially congruent with the shape of the recess 102. In other words, it can extend over a periphery of the body over substantially the same circumferential length as the recess.

It also can have a thickness in a radial direction substantially corresponding to the depth of the recess 102 so as to be fully inserted into the recess 102, and the outer surface of the additional element 103 could be a continuation of an outer surface of a remaining part of the part 101. However, it is of course possible that the outer surface of the electrical or electronic device extends radially inwardly farther than the outer surface of the wall of the hollow container body 101, or to the contrary farther radially outwardly beyond the outer surface of the hollow body 101.

As shown in FIG. 11, the recess 102 and the electrical or electronic device 103 extend over a circumference with an angle over 180° and therefore the electrical or electronic device 103 is held in the recess 102 and is not lost from the hollow part 101.

The ends of the groove 110 can be provided with small local depressions 104 while the ends of the electrical or electronic device 103 can be provided with corresponding projections 105 insertable in the depressions so as to more securely hold the electrical or electronic device 3 on the hollow container body. The cross-sectional shape of the depressions and the projections can be selected so that the projections can be press-fitted into the depressions to increase the security of holding of the electrical or electronic device 103 on the hollow container body.

On the other hand, the vertical dimension along an axis of the hollow container body of the recess and the vertical dimension of the electrical or electronic device 103 can be selected so that the electrical and electronic device 103 can be press fitted into the recess and held it by spring forces.

In the container for beverages in accordance with another embodiment shown in FIG. 15, the recess is formed by a local depression or depressions 106 and not as a circumferentially extending recess as in FIG. 2, and the electrical and electronic device are provided with local projection or projections which are also press-fitted in to the depressions 106, so that the electrical and electronic device can be securely held on the hollow body.

The electrical and electronic device 103 can be substantially transparent, for example translucent, completely or partially. It can be also colored, completely or partially.

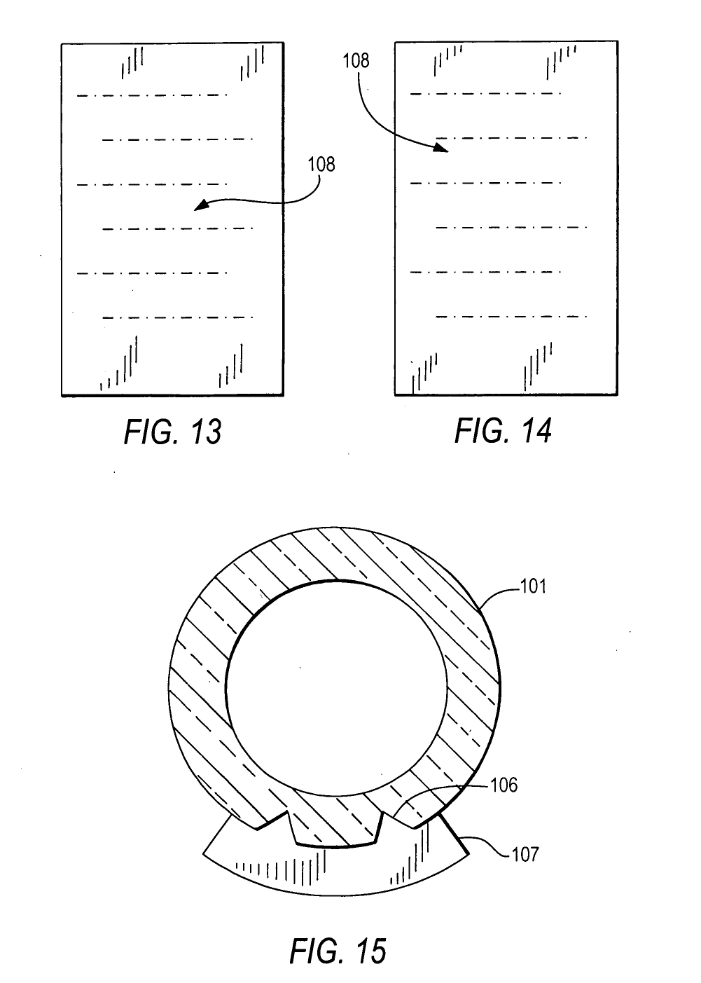

In accordance with the present invention shown in FIGS. 13 and 17, the bracelet for wearing by a user has a member 108 which is insertable between the electrical or electronic device and the hollow body. The additional member can be composed of many materials, for example of paper, cardboard, plastic, etc. As for the electrical and electronic device, it can be composed for example of plastic or another material.

The member 108 has two sides each provided with a corresponding message. When the member is inserted between the electrical and electronic device and the hollow part, the message on one side of the member 108 is visible through the electrical and electronic device, while the message on the opposite side of the member 108 is visible through a transparent wall of the hollow part.

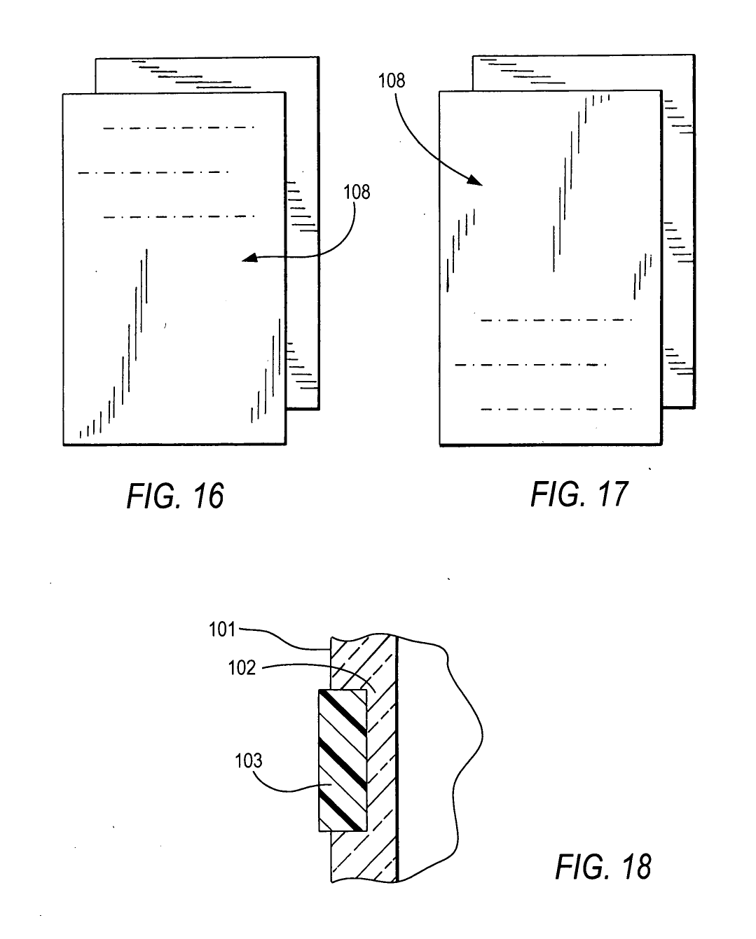

In accordance with another feature of the present invention, the messages can be provided on opposite sides of the electrical and electronic device shown in FIGS. 16 and 17. In accordance with another embodiment, as shown in these figures the messages can occupy only portions of the electrical and electronic device which are spaced from one another. For example as shown in FIG. 18 one side of the additional element 103 is provided with the message on its upper portion, while the other opposite side of the electrical and electronic device is provided with a message on its lower portion. The message of one side is visible from outside, from the message on the other side can be visible through a transparent wall of the hollow part.

The messages on the electrical and electronic device or on the member 108 can be for example personal messages related to an anniversary birth, a holiday, a congratulation, etc. The messages can be specific to the users and can have the names of the users. The messages can include advertising and promotional material, advertising certain events, personalities, etc. The message can be personified messages in particular identifying a person to who the container for beverages belongs.

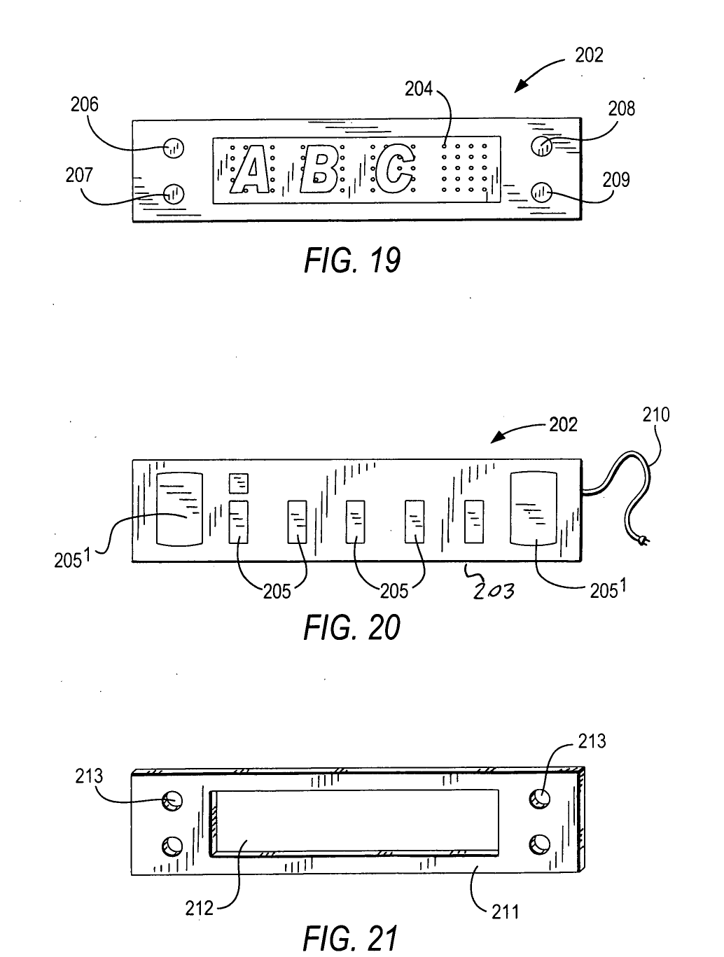

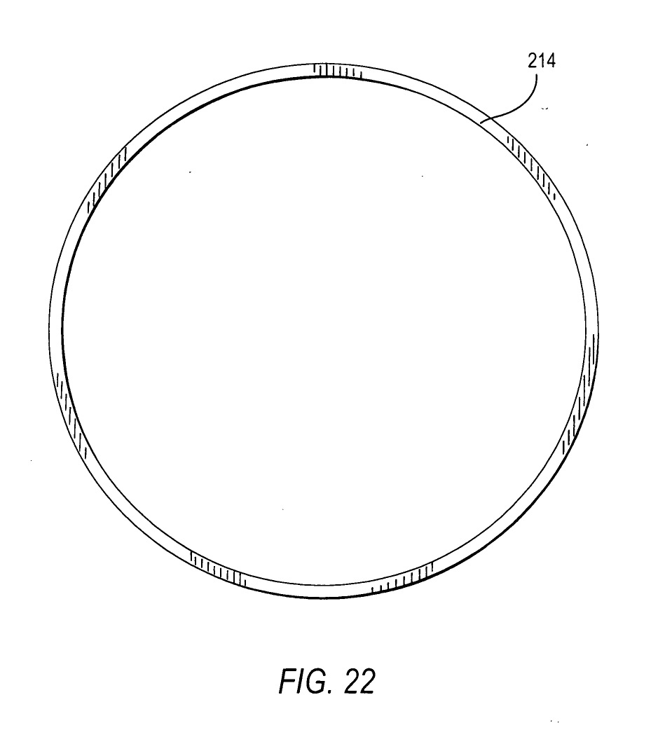

A bracelet for wearing by a user in accordance with the present invention shown in FIGS. 19-22 has a hollow body with a recess identified with reference numeral. An electrical or electronic device 203 is arranged in the recess.

The electronic device 203 has a display which is identified with reference numeral 204. The display 204 can include a plurality of LEDs or OLEDs, for example, for example five rows and twenty-five columns of these illuminating elements.

The electrical or electronic device 203 is further provided with a microprocessor 205. The microprocessor 205 is designed to provide several operational features. The microprocessor 204 has a memory in which individual elements such as letters, numbers, and symbols are stored, and in which also preliminary selected messages are stored as well. The microprocessor also has means for generating corresponding elements (letters, numbers, symbols) and the preliminarily selected messages on the display 204.

The electrical or electronic device further has control means which include an on/off button 206, an entry button 207, an up button 208, and a down button 209.

In accordance with the present invention, the microprocessing means or microprocessor 205 is designed so that it provides generation on the display 204 of running light messages. The electrical or electronic device 203 also has batteries 205′

The electrical or electronic device of the bracelet for wearing by a user operates in the following manner.

When the on/off button is pressed by a user, a preliminarily provided message is displayed on the display 204 as a running light message. By pushing the button 208 or the button 209 the other preliminarily provided message can be selected correspondingly in an ascending order or in a descending order.

A user can compose a new running message to be displayed on the display 204. For this purpose the entry button 207 is pressed, and by pressing the buttons 208 or 209 letters, numbers, or symbols successively appear on the display 204. In order to memorize the corresponding letter, number or symbol, the entry button 207 is pressed again. By repeating this operation a corresponding number of times, a corresponding message can be composed, and then the on/off button is pressed to memorize this message. This running light message which is thusly selected by the user is then displayed on the display 204.

The letters to be selected can be letters of any alphabet, the numbers to be selected can be numbers of any calculation system, and the symbols can be any symbols such as a star, a flag, a geometric figure, a face, etc.

The electrical or electronic device can be provided with an electrical cable 210 to be plugged in a power source to operate the device. A clock can be provided, so as to hold the device operational only for a certain short time, for example 3-5 min.

An intermediate element 211 can be provided between the electrical or electronic device 203 and a bottom of the recess 202 and composed for example of plastic. It can have a hole 212 for protruding display 204 and holes 213 for buttons 216, 217, 218, 219.

A transparent/translucent band 214 can be fitted around the electrical or electronic device 203 to hold it on the container. Also double-sided adhesive inserts 315 can be provided to attach, projections of the electronic to walls of depressions.

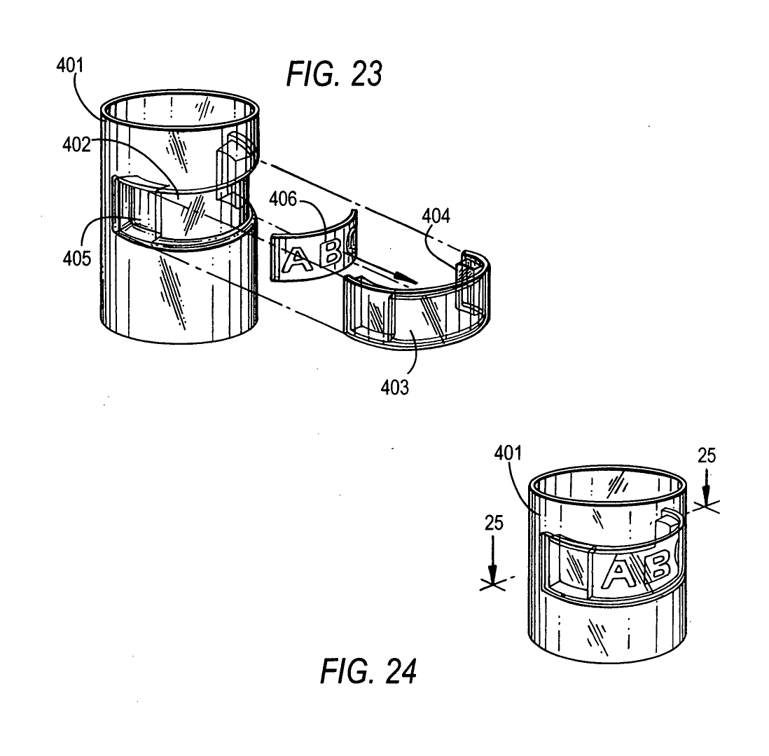

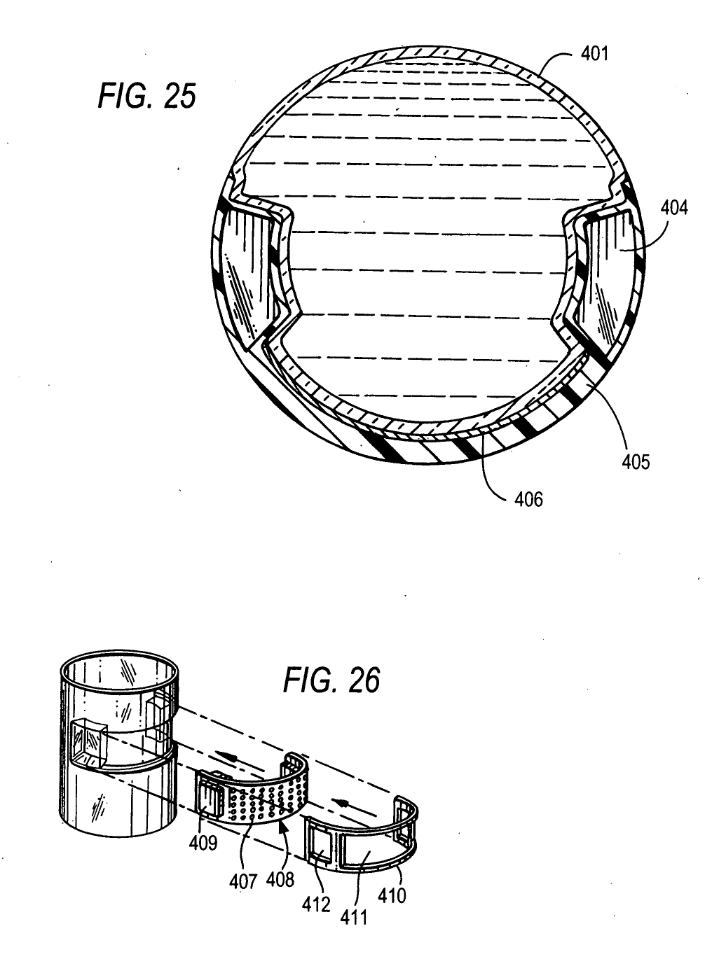

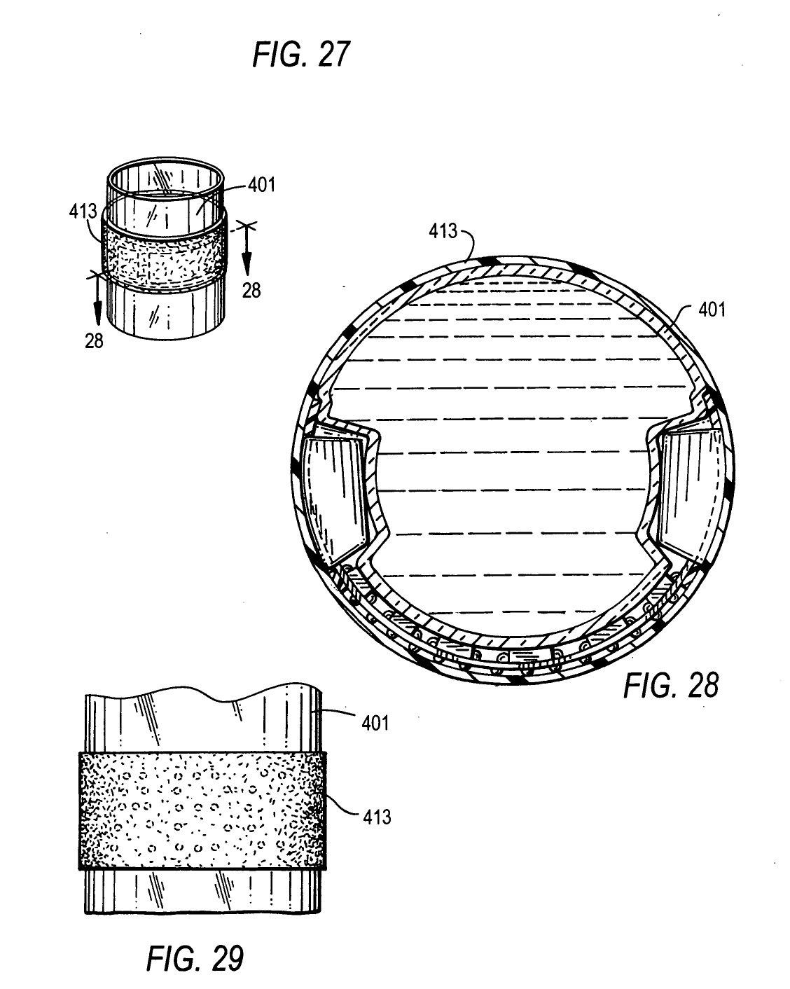

A bracelet for wearing by a user shown in FIGS. 23-29 has a hollow container body which is identified with reference numeral 401. The hollow body has a recess provided in its wall and extending from its surface radially inwardly over a part of a circumference, as identified with reference numeral 402.

The bracelet for wearing by a user in accordance with the present invention further has an additional element which is identified with reference numeral 403. The additional element 403 has a shape which is substantially congruent with the shape of the recess. In other words, it can extend over a periphery of the hollow body over substantially the same circumferential length as the recess.

It also can have a thickness in a radial direction substantially corresponding to the depth of the recess 402 so as to be fully inserted into the recess, so that the outer surface of the additional element 403 could be a continuation of an outer surface of a remaining part of the hollow body. It can also have end projections 404 insertable in depressions 405. An intermediate element 406 is arranged between the additional element and a wall of the and can be provided with a text, images, etc.

The bracelet for wearing by a user in accordance with another embodiment of the present invention has an electronic device 407 which is also insertable in the recess and produces images, such as a text, a picture image, a running light, etc, electronically, for example with the use of LED, OLED, etc. It has a slightly protruding display 408 and control buttons 409. A frame element 410 having openings 411 and 412 for the protruding display and the protruding control buttons is a further provided and also inserted in the recess on top of the device.

Finally, a retaining element 413 is provided for retaining all additional elements in the recess of the body. The retaining element is formed substantially as a band element. The band element can be placed circumferentially over the elements so as to hold them in the recess of the body. The retaining element can be composed of a silicon material, for example PDMS.

The band element can have an inner surface with a diameter substantially corresponding to the diameter of the body so that it snugly passes over the outer surface of the body and fits over the additional element and the remaining portion of the container body.

On the other hand the band element can be composed of an elastic material and can have in this case an inner diameter which is smaller than the outer diameter of the body. In this case the band element can be stretched radially outwardly when it moves over a surface of the body and onto the outer surface of the additional element and the remaining circumferential portion of the body.

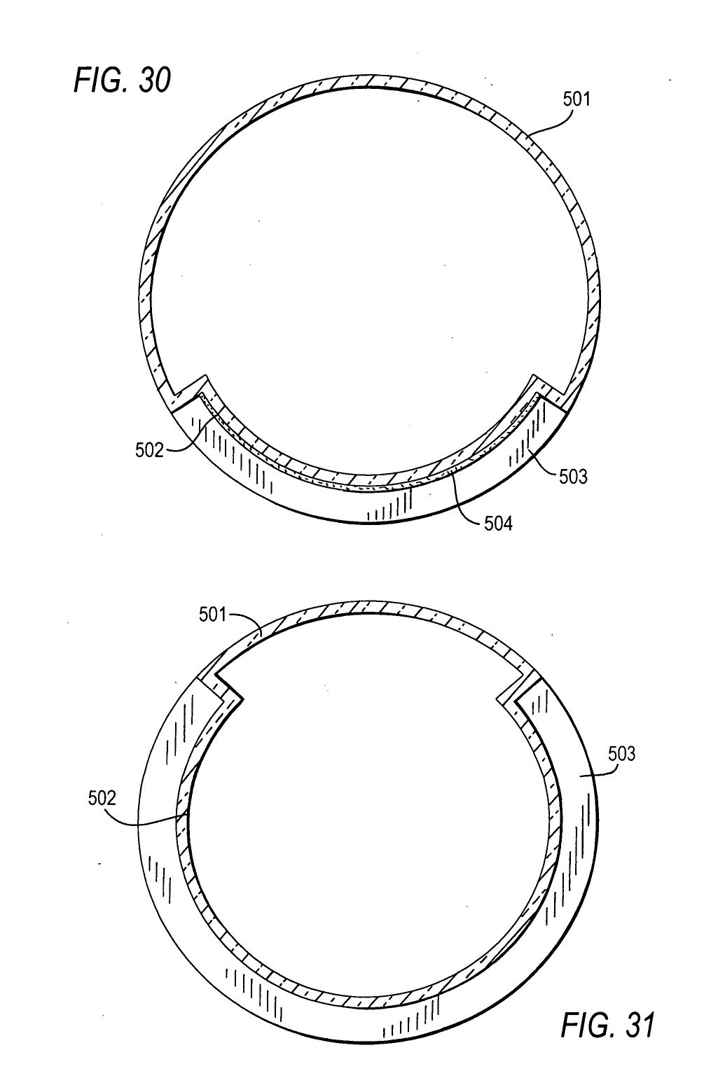

In the embodiment shown in FIG. 30 and the electronic device 503 is formed so that when inserted in the recess, it is firmly held there. The electronic device 503 can be formed for this purpose with dimensions slightly greater that the dimensions (height, width, depth) of the recess, so that when forcibly inserted into the recess 502 due to yieldability of the material of the device and/or body, the device is reliably held there, as shown in FIG. 36.

Also, the electronic device 503 shown in FIG. 31 can be formed as a substantially springy element, which when inserted in the recess 502, is firmly held inside the recess by a spring action of the springy electronic device 3, which surround a part of the body over more than 180° as shown in FIG. 34.

The electronic device 503 can be provided with additional adhesive means formed for example by adhesive layers 504 which are initially covered by a non-adhesive material that later is removed to expose the adhesive means or layers 504, so as to additionally secure the electronic device 503 in the recess 502 on the part of the container body 501.

A bracelet for wearing by a user in accordance with another embodiment of the present invention shown in FIGS. 35-36 has a container body which is identified with reference numeral 601. The bracelet for wearing by a user further has an electronic device provided with a display for displaying electronic messages, identified with reference numeral 602, and capable of displaying video messages composed of letters, numerals, images, running images, lights, etc.

The inventive bracelet for wearing by a user further has means for holding said electronic device on said body and including an additional element 603 connected with said electronic device so as to form together a circumferentially extending unit which as a whole is fittable on said body and tightly held on the latter element. The electronic device 602 and/or the additional element 603 can be somewhat springy.

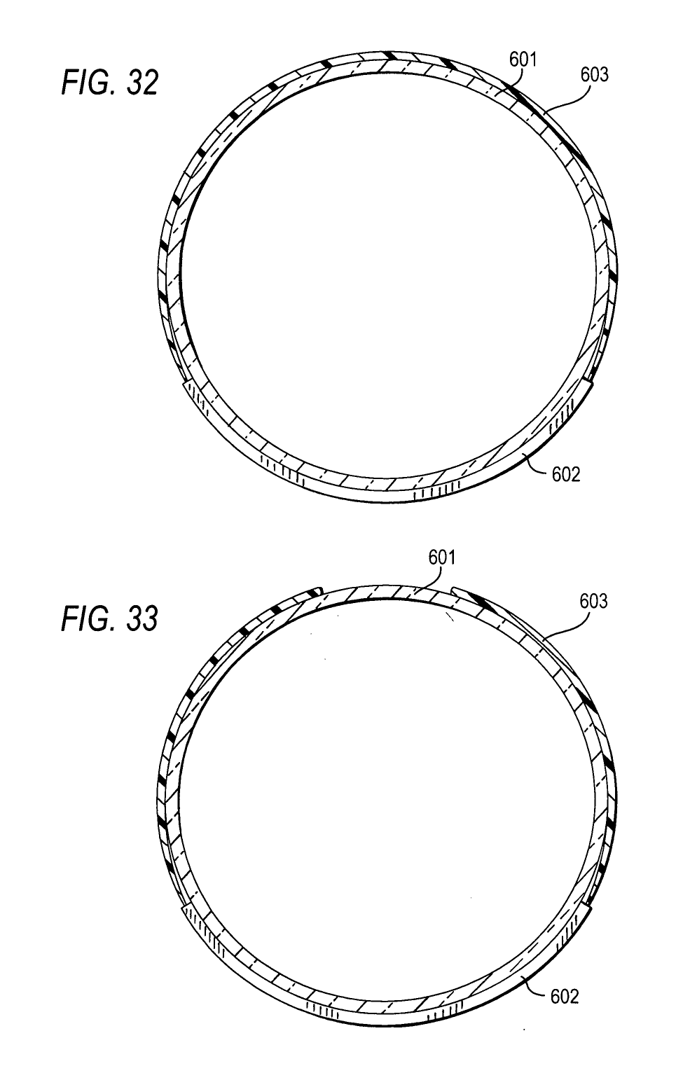

The whole unit can be completely circumferentially closed as shown in FIG. 32, or partially open as shown in FIG. 33.

While the invention has been illustrated and described as embodied in a bracelet for wearing by a user, it is not intended to be limited to the details shown, since various modifications and structural changes may be made without departing in any way from the spirit of the present invention.

It will be understood that each of the elements described above, or two or more together, may also find a useful application in other types of constructions differing from the type described above.

Without further analysis, the foregoing will so fully reveal the gist of the present invention that others can, be applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A bracelet for wearing by a user, comprising a hollow bracelet for wearing by a user body; an electronic or electrical device provided on said hollow bracelet for wearing by a user body; and user-operated means for controlling the device by a user.

2. A bracelet for wearing by a user as defined in claim 1, wherein said device includes an electronic display displaying information, and wherein said means for controlling include an alpha-numerical keyboard.

3. A bracelet for wearing by a user as defined in claim 1; and further comprising a battery for providing a battery operated power operation of said electronic display and/or electric cable for connecting said device to a power source.

4. A bracelet for wearing by a user as defined in claim 1; and further comprising a microprocessor for operating said electronic display.

5. A bracelet for wearing by a user as defined in claim 2; and further comprising input means connectable to an outside device.

6. A bracelet for wearing by a user as defined in claim 2, wherein said means for controlling for switching between several options selected from the group consisting of menu, photos, video.

7. A bracelet for wearing by a user as defined in claim 1, wherein said hollow container body part has at least one cavity, said device being accommodated in said cavity and retained in the latter.

8. A bracelet for wearing by a user as defined in claim 7; and further comprising means for closing said cavity and covering said device from outside.

9. A bracelet for wearing by a user as defined in claim 7, wherein said device is configured as a ring-shaped device.

10. A bracelet for wearing by a user as defined in claim 1, wherein said device is configured as a device producing messages selected from the group consisting of a visual message, an audio message, a decorative message, and a combination thereof.

11. A bracelet for wearing by a user as defined in claim 1, wherein said device has light generating means and also sensing means selected from the group consisting of a contact sensor, a movement sensor, and both operative for activating said light generating means for producing light in response to an action selected from the group consisting of a contact, a movement, and both in a vicinity of said device.

14. A bracelet for wearing by a user as defined in claim 1, wherein said electrical and electronic device is substantially transparent and/or colored.

15. A bracelet for wearing by a user as defined in claim 1, wherein said body has a recess which extends over more than 180°, said electrical and electronic device extending over more than 180° as well.

16. A bracelet for wearing by a user as defined in claim 1, wherein said body has a recess with a shape, and said electrical and electronic device has a portion with a shape such that said portion can be press-fitted in to said recess.

17. A bracelet for wearing by a user as defined in claim 28, wherein said electrical and electronic device provides a message selected from the group consisting of a personal message, a running light message, a message preliminarily stored message, an advertising message, a proprietary message, and combination thereof.

18. A bracelet for wearing by a user as defined in claim 1, wherein said device includes microprocessor means and a display on said display means, said controlling means providing displaying of elements selected from the group consisting of letters, numbers and symbols thus enabling a user to compose a message in a corresponding order.

19. A bracelet for wearing by a user as defined in claim 1, wherein said bracelet body and said electrical or electronic device form together a circumferentially extending unit which is fittable on a surface a part of a user's body and is circumferentially open or closed.

20. A bracelet for wearing by a user as defined in claim 1, wherein said electrical or electronic device is connected with said hollow body in a manner selected from the group consisting of detachably connectable and non-detachably connectable.
